(19) United States
(12) Patent Application Publication
(10) Pub. No.: US 2016/0124632 A1
(43) Pub. Date: May 5, 2016

(54) INFORMATION PROCESSING APPARATUS AND METHOD FOR CONTROLLING INFORMATION PROCESSING APPARATUS

(71) Applicant: SHARP KABUSHIKI KAISHA, Osaka-shi, Osaka (JP)

(72) Inventors: Toshiyuki KAMEI, Osaka-shi (JP); Miho KAGEI, Osaka-shi (JP)

(21) Appl. No.: 14/890,929

(22) PCT Filed: Jul. 9, 2014
(86) PCT No.: PCT/JP2014/068309

§ 371 Date: Nov. 13, 2015

(30) Foreign Application Priority Data
Jul. 9, 2013 (JP) 2013-143949

(51) Int. Cl. G06F 3/0488; G06F 3/0484; G06F 3/0481; G06F 3/0482

(52) U.S. Cl. CPC G06F 3/04883; G06F 3/0482; G06F 3/04842; G06F 3/04817; G06F 2203/04808

(57) ABSTRACT

The smartphone (1) of the present invention includes: an object specifying section (12) for specifying, based on a contact position detected by an input section (20), at least one object which is displayed on a display section (30); and a file moving section (13) for, in a case where the at least one object is associated with a folder, moving a file stored in the folder to an outside of the folder.

### TECHNICAL FIELD

The present invention relates to an information processing apparatus including a touch panel. More specifically, the present invention relates to an information processing apparatus and a control program each for managing, with use of a folder, a plurality of objects and data which is associated with the plurality of objects.

### BACKGROUND ART

In an electronic device including a touch panel, collective management of various types of data in units of folders is widely carried out, as with a conventional personal computer (PC). However, unlike the conventional PC, various inputs to the electronic device including a touch panel are generally carried out without using a mouse or a keyboard. Under the circumstances, attempts have been made to develop a technique for easily managing a file and a folder even in a case where an operation is carried out through a touch panel. For example, each of Patent Literatures 1 and 2 discloses a technique for simplifying creation of a folder and storage of a file.

Meanwhile, even on the electronic device including a touch panel, an operation to move a file stored in a folder to the outside of the folder (i.e., an operation to change a storage location of a file) is generally carried out with the same operational processes as those used for the conventional PC. Specifically, a file stored in a folder has conventionally been moved to the outside of the folder by the following processes. That is, (i) a folder is first opened, (ii) a file that is needed to be moved to the outside of the folder is selected from files stored in the folder, and (iii) the selected file is then moved to the outside of the folder through a predetermined operation such as a drug-and-drop operation.

### CITATION LIST

### Patent Literature

### [Patent Literature 1]

Japanese Patent Application Publication Tokukai No. 2012-008916 (Publication Date: Jan. 12, 2012)

### [Patent Literature 2]

Japanese Patent Application Publication Tokukai No. 2005-198064 (Publication Date: Jul. 21, 2005)

### SUMMARY OF INVENTION

### Technical Problem

As such, in a case where a user attempts to move a file stored in a folder to the outside of the folder while using an electronic device including a touch panel, the user needs to carry out an operation in procedures similar to those of a conventional personal computer, and doing such an operation on the electronic device including a touch panel is troublesome. That is, in order to move a file stored in a folder to the outside of the folder, the user has to sequentially carry out, on a touch panel, (i) an operation to open a folder, (ii) an operation to select a file, and (iii) an operation to move the file to the outside of the folder. The present invention is attained in view of the above problem. An object of the present invention is to provide an information processing apparatus and a control program that make it possible to more efficiently carry out an operation to move a file stored in a folder to the outside of the folder.

### Solution to Problem

In order to attain the above object, an information processing apparatus in accordance with an aspect of the present invention includes: a display section for displaying an object on a display screen; an input section for detecting a contact position of an indicator on the display screen; an object specifying unit for specifying, based on the contact position detected by the input section, at least one object from objects which are displayed on the display screen; and a file moving unit for, in a case where the at least one object is associated with a folder, moving a file stored in the folder to the outside of the folder.

### Advantageous Effects of Invention

According to the above aspect of the present invention, it is possible to more efficiently carry out an operation to move a file stored in a folder to the outside of the folder.

### BRIEF DESCRIPTION OF DRAWINGS

FIG. 1 is a block diagram illustrating a configuration of a substantial part of a smartphone in accordance with the present invention.

FIG. 2 shows an example of a data structure of a display list to be used by the smartphone.

FIG. 3 is a flow chart showing an example of a process to be carried out by the smartphone.

FIG. 4 shows, in (a) and (b), examples of (i) an operation to be carried out by a user with respect to the smartphone and (ii) a display screen.

FIG. 5 shows, in (a) and (b), other examples of (i) an operation to be carried out by a user with respect to the smartphone and (ii) a display screen.

FIG. 6 shows, in (a) through (d), still other examples of (i) an operation to be carried out by a user with respect to the smartphone and (ii) a display screen.

FIG. 7 shows, in (a) through (d), yet other examples of (i) an operation to be carried out by a user with respect to the smartphone and (ii) a display screen.

FIG. 8 shows, in (a) through (d), yet other examples of (i) an operation to be carried out by a user with respect to the smartphone and (ii) a display screen.

FIG. 9 shows, in (a) and (b), yet other examples of (i) an operation to be carried out by a user with respect to the smartphone and (ii) a display screen.

FIG. 10 shows, in (a) and (b), yet other examples of (i) an operation to be carried out by a user with respect to the smartphone and (ii) a display screen.

FIG. 11 shows, in (a) through (d), yet other examples of (i) an operation to be carried out by a user with respect to the smartphone and (ii) a display screen.

### DESCRIPTION OF EMBODIMENTS

### Embodiment 1

The following description discusses Embodiment 1 of the present invention. Embodiment 1 describes an example in which an information processing apparatus in accordance with the present invention is realized by a smartphone. Note, however, that a form in which the present invention is realized is not limited to the smartphone. The present invention is applicable to any information processing apparatus in any size, provided that such an information processing apparatus is capable of including a configuration discussed below.

<<Configuration of Substantial Part>>

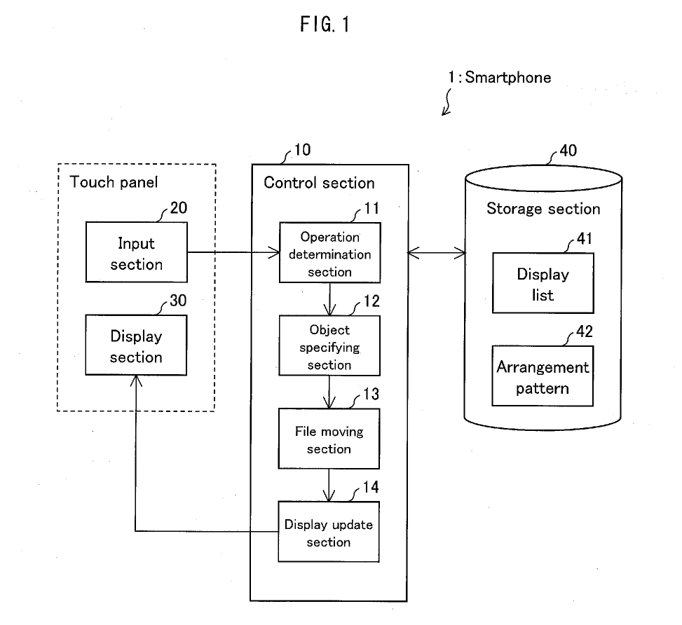

First, the following description discusses a configuration of a substantial part of the smartphone with reference to FIG. 1. FIG. 1 is a block diagram illustrating a configuration of a substantial part of a smartphone 1 (an information processing apparatus). Note that a configuration which is not directly relevant to a configuration of the invention is omitted in FIG. 1. Note, however, that the smartphone 1 can include the omitted configuration in accordance with actual conditions of implementation. The smartphone 1 is a device which includes a touch panel and is capable of displaying at least one object on the touch panel. Further, the smartphone 1 is a device capable of accepting an operation carried out by a user with respect to an object, specifically, an operation to select an object.

Note that it is only necessary that the object (i) be to be selected by a user and (ii) be associated in advance with a specific process or data. Specific examples of the object encompass (i) shortcut icons for an application and various functions which are provided in the smartphone 1 and (ii) icons indicating various files and folders. The smartphone 1 is a device capable of managing data by storing, in a folder, the data with which the object is associated.

As illustrated in FIG. 1, the smartphone 1 includes a control section 10, an input section 20, a display section 30, and a storage section 40. Note that an input surface of the input section 20 and a display surface of the display section 30 are integrally provided as the touch panel. The display section 30 displays an image in accordance with control carried out by the control section 10. Examples of the display section 30 encompass a flat display panel such as a liquid crystal panel and an organic EL panel. The display section 30 displays an object on the display screen in accordance with information received from a display update section 14 (described later). The input section 20 accepts a touch input carried out by a user with respect to the smartphone 1. The input section 20 obtains, at predetermined time intervals, two-dimensional coordinate information (touch coordinates), on the input surface, of a finger of a user, an indicator, or the like which has been brought into contact with the input surface. The input section 20 transmits data of the obtained series of touch coordinates to an operation determination section 11 as a track of the touch coordinates (touch position). Note that a configuration of the input section 20 of Embodiment 1 and a method of detecting a touch operation by the input section 20 of Embodiment 1 are not particularly limited to specific ones, provided that the input section 20 is capable of detecting at least two touches (multi-touch) at predetermined time intervals. In a case where the input section 20 is capable of detecting a finger which is in the vicinity of the input surface, it is possible for the input section 20 to (i) obtain, instead of the touch coordinates, coordinates representing a position of the finger in the vicinity of the input surface at predetermined time intervals and (ii) send the coordinates thus obtained to the operation determination section 11.

The storage section 40 stores various types of data (data such as a file and a program and data of an object such as an icon) to be used in the smartphone 1. As illustrated in FIG. 1, the storage section 40 stores a display list 41 and an arrangement pattern 42.

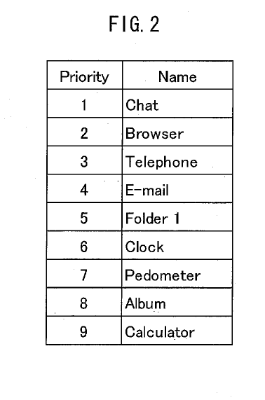

The display list 41 is information for determining display priorities based on which objects are displayed (i.e., determining an order in which objects are to be arranged) in the display section 30. More specifically, the display list 41 is information in which the display priorities are associated with pieces of information specifying the objects. The display list 41 is rewritten by a file moving section 13 (described later). Further, the display list 41 is read out by the display update section 14 (described later). FIG. 2 shows an example of a data structure of the display list 41. As illustrated in FIG. 2, the display list 41 contains a “priority” column and a “name” column, and pieces of information in the “priority” column are associated with respective pieces of information in the “name” column. Note that the data structure of the display list 41 is not limited to a table format, and it is only necessary that the display list 41 be information in accordance with which the display priorities on the display screen can be specified. The “priority” column stores pieces of information indicative of the display priorities based on which objects are displayed. The pieces of information may be freely changeable by a user. Further, the pieces of information can be stored in any format, provided that the display priorities can be uniquely determined in accordance with the pieces of information. For example, the priorities in the “priority” column do not necessarily need to be indicated by consecutive numbers. The “name” column stores pieces of information respectively indicative of names of objects. Note that the pieces of information in the “name” column can be stored in any format, provided that the pieces of information are capable of uniquely indicating respective various objects.

The arrangement pattern 42 is information in which positions on the display screen of the display section 30 are associated with the respective display priorities of the objects. In other words, the arrangement pattern 42 is information defining positions on the display screen at which positions objects having respective given priorities are to be arranged. The arrangement pattern 42 does not particularly limit arrangement positions of the objects or an arranging method, provided that the arrangement positions of the objects are uniquely determined in accordance with the display priorities. Note that, according to Embodiment 1, the arrangement pattern 42 is defined in the following manner.

### Arrangement Pattern in Embodiment 1

In Embodiment 1, the display screen of the display section 30 is divided into predetermined grid-like partitions and objects are arranged in the respective predetermined grid-like partitions in accordance with the display priorities. More specifically, for example, objects can be arranged in the respective partitions as follows: i.e., a first object having a highest priority (indicated by a smallest number in the “priority” column in the display list 41) is arranged in an upper-leftmost partition of the display screen; objects having lower priorities are arranged side by side toward right, in a descending order of priority, in respective partitions; and when an object is arranged in a rightmost partition in a column, another object having a priority immediately following that of the rightmost object is to be arranged in a leftmost partition in a next (lower) column. In this manner, the objects can be arranged until the display screen is filled with the objects.

The control section 10 comprehensively controls the smartphone 1. The control section 10 is realized by a CPU (central processing unit), for example. The control section 10 includes the operation determination section 11 (operation determination unit), an object specifying section 12 (object specifying unit), the file moving section 13 (file moving unit, file arrangement determination unit, position specifying unit), and the display update section 14. The operation determination section 11 determines a type of operation carried out by a user with respect to the input section 20. Upon receipt of a track of touch coordinates from the input section 20, the operation determination section 11 determines, in accordance with the track, whether or not an operation carried out with respect to the input surface of the input section 20 is a pinch-out operation. The pinch-out operation refers to an operation to move a plurality of fingers (or indicators) while the plurality of fingers are kept in contact with the input surface so that a gap between the plurality of fingers becomes larger. The operation determination section 11 can determine the pinch-out operation in any manner. For example, the operation determination section 11 may determine that the pinch-out operation has been carried out in a case where (i) there exist two sets of touch coordinates serving as starting points of tracks and (ii) each of the tracks is drawn from its starting point so as to be apart from the starting point of the other one of the tracks. In a case where the operation determination section 11 has determined that an operation which has been carried out by a user is a pinch-out operation, the operation determination section 11 transmits, to the object specifying section 12, the starting points of the tracks, i.e., the two sets of coordinates representing the starting points of the pinch-out operation.

The object specifying section 12 specifies (i) an object (selected object) selected by the pinch-out operation and (ii) whether or not the selected object indicates a folder. Upon receipt, from the operation determination section 11, of the two sets of coordinates representing the starting points of the pinch-out operation, the object specifying section 12 specifies the selected object based on the two sets of coordinates. The object specifying section 12 only needs to specify at least one object based on the two starting points which have been received, and a method for specifying the at least one object is not limited to a particular one. Note that in Embodiment 1, the object specifying section 12 (i) calculates coordinates representing a middle point of a line segment connecting two starting points, and then (ii) specifies, as the selected object, an object arranged at a coordinate position of the middle point. Hereinafter, the middle point will be referred to as a “middle point of starting points”. The object specifying section 12 then determines whether or not the selected object is associated with a folder (i.e., whether or not the selected object is a folder icon or the like). Specifically, the object specifying section 12 determines whether or not the selected object is associated with a folder by, for example, referring to data (not illustrated) of the selected object which data has been stored in the storage section 40. In a case where the selected object is associated with a folder, the object specifying section 12 transmits, to the file moving section 13, a piece of information indicative of the folder (selected folder) which corresponds to the selected object.

Note that the selected folder can be, other than a normal folder, an object indicative of a file such as a zip format file in which a plurality of files are compressed together. In a case where there exists no object on the display screen at the coordinate position of the middle point of starting points, the object specifying section 12 does not need to transmit, to the file moving section 13, a piece of information indicative of a selected folder. Alternatively, the object specifying section 12 may transmit, to the file moving section 13, a piece of information which indicates that the object specifying section 12 could not specify a selected folder.

The file moving section 13 specifies a file stored in the selected folder, and moves the file to the display screen (i.e., changes a storage location of the file from a hierarchy under the selected folder to a hierarchy indicated by the display screen). Specifically, upon receipt, from the object specifying section 12, of the piece of information indicative of the selected folder, the file moving section 13 specifies a file stored in the selected folder, and then changes a storage location of the specified file from the hierarchy under the selected folder to the hierarchy indicated by a screen which is currently displayed (for example, a hierarchy just below a “desktop” folder). That is, the file moving section 13 moves the file from the inside of the selected folder to the hierarchy indicated by the display screen. After that, the file moving section 13 updates the display list 41. Specifically, the file moving section 13 adds, to the display list 41, a name and a display priority of the specified file. In a case where the file moving section 13 has deleted the selected folder, the file moving section 13 also deletes, from the display list 41, a piece of information indicative of an object associated with the selected folder. After updating the display list 41, the file moving section 13 transmits, to the display update section 14, a control order instructing update of a screen display.

Note that, in a case where there exists no file in the selected folder (i.e., in a case where the selected folder is empty) after movement of a file from the selected folder to the display screen, the file moving section 13 may delete the selected folder. Alternatively, in a case where there exists a single file in the selected folder after the movement of a file, the file moving section 13 may (i) delete the selected folder and (ii) move the single file to the hierarchy indicated by the display screen. In other words, in a case where there exists only one file in the selected folder after the movement of a file, the file moving section 13 may unfold the folder and change a hierarchy of the one file to a higher one.

Further, in a case where the specified object is a compressed format file such as a zip format file, the file moving section 13 only needs to (i) convert (decompress) the compressed format file into a normal format file and (ii) carry out the above process with respect to a plurality of files which were compressed together in the compressed format file. In adding the piece of information to the display list 41, the file moving section 13 may determine the display priority of the specified file in any manner. In Embodiment 1, the file moving section 13 determines that display priorities of files which have been moved to the display screen are represented by consecutive numbers which start from the same number as that of the object associated with the selected folder. Further, the file moving section 13 adds pieces of information indicative of these display priorities to the display list 41. In a case where a file which has been moved to the display screen has the same display priority as that of another object (which has been stored in the display list 41 earlier than the addition), the file moving section 13 changes the display priority of the another object to a lower one.

The display update section 14 determines an object to be displayed on the display screen and an arrangement of the object, and transmits information of the object and the arrangement of the object to the display section 30. Upon receipt, from the file moving section 13, of the control order instructing update of the screen display, the display update section 14 reads out, from the display list 41 in the storage section 40, a name of the object and a display priority of the object. Subsequently, the display update section 14 reads out, from the storage section 40, (i) image data (not shown) which is of the object and corresponds to the name of the object and (ii) an arrangement pattern 42. The display priority, the image data, and the arrangement pattern 42, which have been read out, are transmitted to the display section 30.

<<Flow of Processes>>

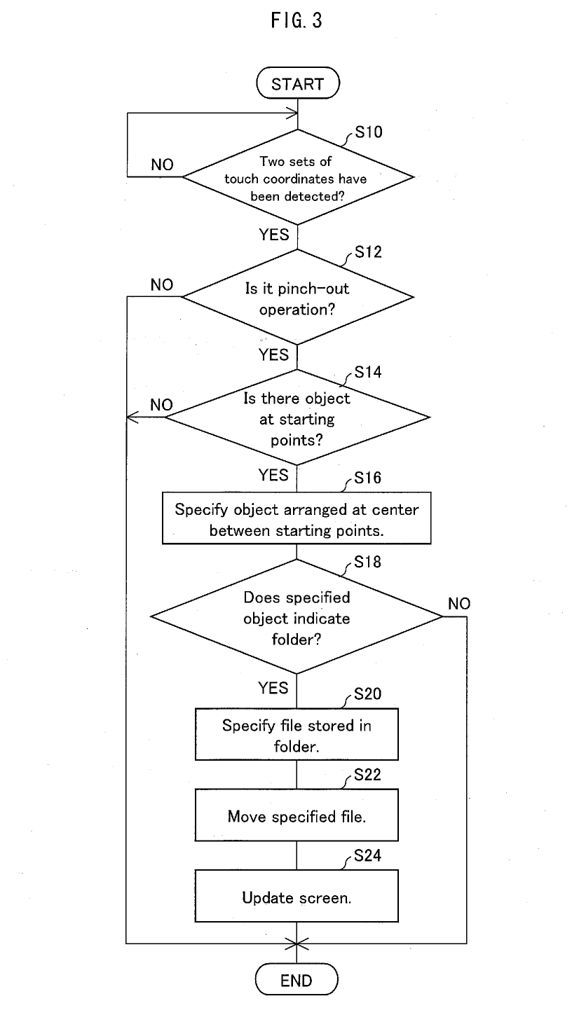

The following description discusses, with reference to FIG. 3, a flow of processes to be carried out by the smartphone 1. FIG. 3 is a flow chart showing the flow of processes to be carried out by the smartphone 1. First, when a user has started an operation (touch operation) with respect to the input surface of the input section 20, the input section 20 detects, at predetermined time intervals, coordinates representing a position touched by the user (i.e., touch coordinates), and transmits, to the operation determination section 11, series of touch coordinates as a track of the touch coordinates. Upon receipt of the track of the touch coordinates from the input section 20, the operation determination section 11 first determines whether or not the track is tracks starting from respective two sets of touch coordinates (S10). In a case where the track is tracks starting from respective two sets of touch coordinates (YES in S10), the operation determination section 11 further determines, in accordance with the tracks starting from the respective two sets of touch coordinates, whether or not the operation carried out with respect to the input section 20 is a pinch-out operation (S12). In a case where the operation determination section 11 determines that the operation is a pinch-out operation (YES in S12), the operation determination section 11 transmits, to the object specifying section 12, the two sets of coordinates (i.e., starting points of the pinch-out operation) from which the respective tracks have started. Note that, in a case where the number of the starting points of the tracks received by the operation determination section 11 is not two (NO in S10), processes subsequent to S10 are not to be carried out until the input section 20 detects two touch positions. In a case where the operation determination section 11 determines that the operation is not a pinch-out operation (NO in S12), the process is ended.

Subsequently, upon receipt, from the operation determination section 11, of coordinates representing a middle point of the starting points of the pinch-out operation, the object specifying section 12 specifies, as a selected object, an object arranged at a position indicated by the coordinates representing the middle point of the starting points on the display screen (S16). Then, the object specifying section 12 further specifies whether or not the specified object (selected object) indicates a folder (S18). In a case where the selected object indicates a folder (YES in S18), the object specifying section 12 transmits a piece of information indicative of the folder (selected folder) which corresponds to the selected object. Note that, in a case where the selected object does not indicate a folder (NO in S18), the process is ended.

Subsequently, upon receipt of the piece of information indicative of the selected folder from the object specifying section 12, the file moving section 13 specifies files stored in the selected folder (S20), and moves the specified files to the display screen (S22). After the process in S22 has been completed, the file moving section 13 updates the display list 41, and transmits, to the display update section 14, a control order instructing update of a screen display. Lastly, upon receipt of the control order, the display update section 14 (i) reads out, from the display list 41, a display priority of an icon and (ii) transmits, to the display section 30, the display priority of the icon together with an image of the icon and an arrangement pattern 42 which have been read out from the storage section 40. The display section 30 (i) arranges, in accordance with the display priority of the icon and the arrangement pattern 42 which have been received from the display update section 14, the image of the icon which has been also received from the display update section 14 and thus (ii) updates the display screen (S24).

By carrying out the process described above, the smartphone 1 (i) specifies, in response to a pinch-out operation, as a selected object, an object arranged at a position that is indicated by coordinates representing a middle point of starting points of the pinch-out operation, and (ii) specifies, as a selected folder, a folder that is associated with the object thus specified. The smartphone 1 then moves a file stored in the selected folder to the display screen (i.e., changes a storage location of the file from a hierarchy under the selected folder to a hierarchy indicated by the display screen). That is, the smartphone 1 (i) enables the user to select a folder through a single pinch-out operation and (ii) moves a file stored in the folder to the outside of the folder.

Further, the file moving section 13 specifies any number of files regardless of the number of and types of the files, provided that the files are stored in the selected folder. Thus, the smartphone 1 can (i) specify, in response to a single pinch-out operation, any number of files stored in the selected folder regardless of the number of the files, and (ii) collectively move the specified files. It is therefore possible to move files stored in a folder to the outside of the folder regardless of the number of the files.

Further, the file moving section 13 determines, in accordance with an arrangement position (display priority) of the selected object on the display screen, an arrangement position of a file to be moved from the selected folder, and then updates the display list 41. This makes it possible to display a file which has been moved from the folder (i.e., a file whose storage location has been changed) at a position associated with a position at which the selected folder was originally arranged. This therefore allows the user to intuitively recognize a destination (arrangement position) to which the file has been moved.

<<Example of Display Screen>>

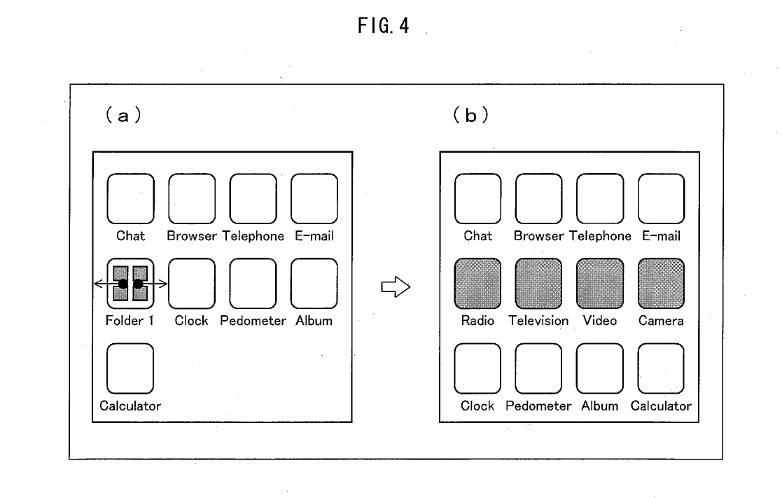

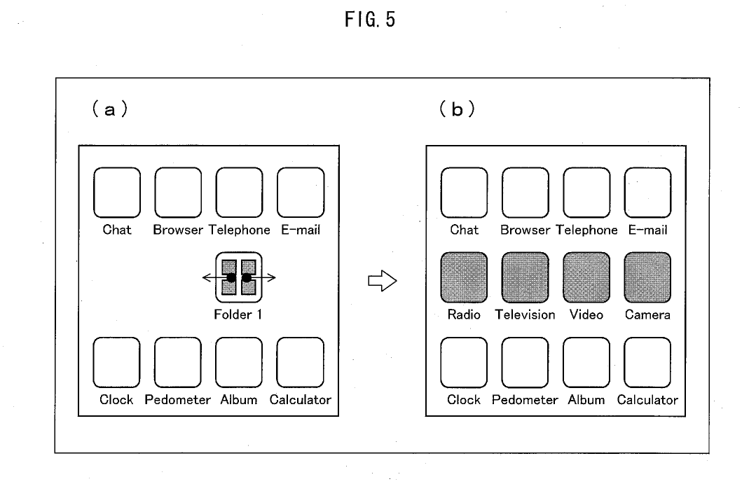

Lastly, the following description discusses, with reference to FIGS. 2 and 4, an operation and display control to be carried out by the smartphone 1. (a) of FIG. 4 illustrates a display screen and an operation to be carried out by a user with respect to the display screen. (b) of FIG. 4 illustrates the display screen which have been subjected to the operation illustrated in (a) of FIG. 4. Note that the display list 41 shown in FIG. 2 is a display list for displaying the display screen illustrated in (a) of FIG. 4. Black dots illustrated in (a) of FIG. 4 indicate starting points of a pinch-out operation carried out by the user. Arrows illustrated in (a) of FIG. 4 indicate tracks in which the user's fingers have been moved. The same applies to black dots and arrows illustrated in FIGS. 5 through 11. Note that the black dots and the arrows are illustrated so as to schematically show the operation carried out by the user, and thus, these items do not need to be actually displayed on the display screen.

As illustrated in (a) of FIG. 4, icons are arranged in a matrix of 4 (vertical)×3 (horizontal) on the display screen of the display section 30. A “folder 1” icon is an icon (folder icon) associated with a folder that is named “folder 1”, and other icons are shortcut icons of applications. The “folder 1” folder stores files indicative of four shortcut icons “radio”, “television”, “video”, and “camera” (though not illustrated in (a) of FIG. 4). Note that, in FIGS. 4 through 11, icons of files stored in the “folder 1” folder are displayed in reduced sizes in the icon indicative of the “folder 1” folder, but these icons of the files are not necessarily displayed in reduced sizes in the icon indicative of the “folder 1” folder. The following description discusses a case where a user has carried out a pinch-out operation on the display screen as illustrated in (a) of FIG. 4. In this case, the “folder 1” icon is arranged at a middle point between starting points of the pinch-out operation. From this, the object specifying section 12 (i) specifies the “folder 1” icon as a selected object, and (ii) specifies, as a selected folder, the “folder 1” folder associated with the “folder 1” icon. The object specifying section 12 then transmits a piece of information indicative of the “folder 1” folder to the file moving section 13.

Subsequently, the file moving section 13 specifies a file stored in the “folder 1” folder. In this case, four files are stored in the “folder 1” folder as described above, and thus the file moving section 13 specifies the four files. The file moving section 13 then moves the four files to the display screen (i.e., changes a storage location of each of the four files from a hierarchy under the “folder 1” folder to a hierarchy that is currently indicated by the display screen). The file moving section 13 then rewrites information in the display list 41. Specifically, the file moving section 13 (i) deletes a piece of information indicative of the “folder 1” icon from the display list 41, (ii) associates names of the four files, which have been moved, with respective display priorities, and (iii) inserts pieces of information indicative of the names and the display priorities of the four files into the display list 41. Lastly, the display update section 14 updates the display screen in accordance with the display list 41 thus updated. That is, the shortcut icons are arranged in a Z-shape order from an upper-left partition of the display screen in a descending order of display priority. On the display screen, the four shortcut icons “radio”, “television”, “video”, and “camera” are thus arranged in this order from a position at which the “folder 1” icon was located (i.e., from a position at which an object having a fifth display priority is displayed) (see (b) of FIG. 4).

### Embodiment 2

According to Embodiment 1, the arrangement positions of the objects to be displayed on the display screen are determined in accordance with (i) the display priorities of the objects which priorities are stored in the display list 41 and (ii) the arrangement pattern 42. Note, however, that the display list 41 and the arrangement pattern 42 are not essential to the present invention. In a case where the display list 41 and the arrangement pattern 42 are not used, it is possible that arrangement positions of objects to be displayed on the display screen are set for each object, and the arrangement positions thus set are stored in the storage section 40. In this case, for example, it is possible that a blank area irregularly exists between objects. Alternatively, it is possible that a user arbitrarily changes arrangement positions of objects.

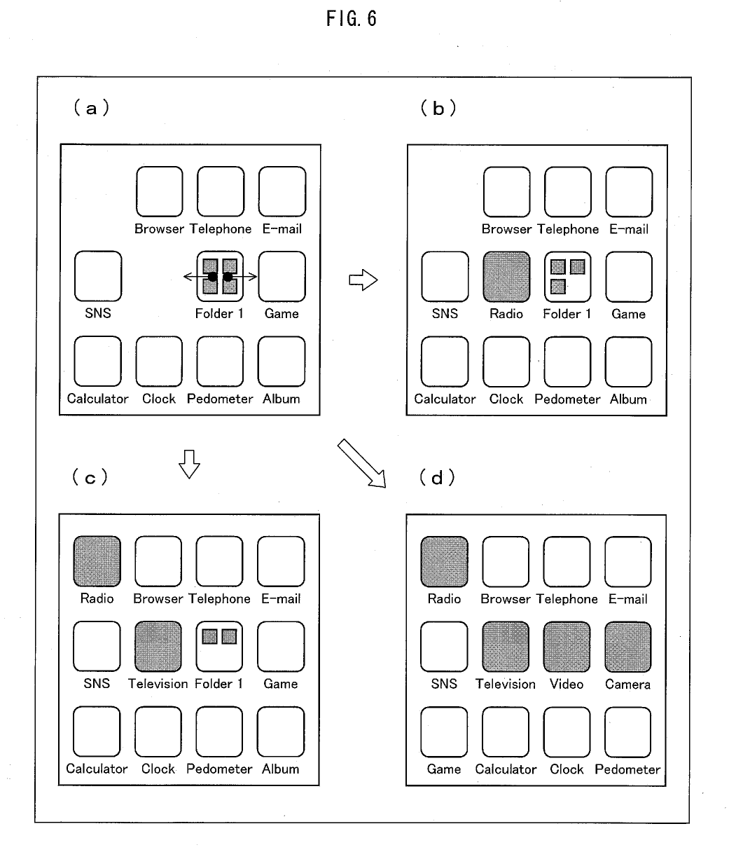

In Embodiment 2, the following description discusses, with reference to FIGS. 5 and 6, another example arrangement of files which have been moved from a selected folder to the display screen. Each of FIGS. 5 and 6 illustrates examples of an operation and display control to be carried out by the smartphone 1 in response to a user's operation in a case where the display list 41 and the arrangement pattern 42 are not used. For convenience of explanation, members having functions identical to those described in Embodiment 1 are given the same reference numerals, and the explanations of such members are omitted. The same applies to the following embodiments and the modified example.

First, the following description discusses, with reference to FIG. 5, an example in which files to be moved from the selected folder to the display screen are to be arranged so as to fill the blank areas. Hereinafter, each of files to be moved from the selected folder to the display screen is referred to as a “move target file”. (a) of FIG. 5 illustrates an operation to be carried out by a user with respect to the display screen. (b) of FIG. 5 illustrates the display screen which have been subjected to the operation illustrated in (a) of FIG. 5. Note that the operation illustrated in (a) of FIG. 5 is identical to that illustrated in (a) of FIG. 4. On the display screen illustrated in (a) of FIG. 5, there are blank areas for three icons on both sides of a “folder 1” folder. In a case where the user has carried out a pinch-out operation as illustrated in (a) of FIG. 5, each section of the smartphone 1 first carries out the same processes as those carried out up to S20 of Embodiment 1. That is, a selected object, a selected folder, and files stored in the selected folder are specified. The file moving section 13 then determines an arrangement position of each of the specified files, and stores the arrangement positions in the storage section 40. The file moving section 13 can determine the arrangement positions of the specified files in any manner, e.g., in such a manner that the file moving section 13 (i) first refers to arrangement positions which (a) are of objects that have already been displayed on the display screen and (b) are stored in the storage section 40, and then (ii) determines that the specified files are to be arranged at positions (in blank areas) which do not overlap with the arrangement positions of the objects which have already been displayed. Alternatively, the file moving section 13 may (i) refer to, among the arrangement positions of the objects which have already been displayed, an arrangement position of the selected object, and (ii) sequentially arrange objects associated with the specified files in blank areas from a blank area that is closer to the arrangement position of the selected object.

Subsequently, the file moving section 13 (i) moves the files, whose arrangement positions have been determined, to the display screen (i.e., changes a storage location of the files), and then (ii) transmits, to the display update section 14, a control order instructing update of a screen display. The display update section 14 reads out, instead of the display list 41 and the arrangement pattern 42, the stored arrangement positions of the objects, and then transmits the arrangement positions to the display section 30. After that, one of the four icons “radio”, “television”, “video”, and “camera” is arranged at a position at which the “folder 1” icon was displayed, and the other three icons are arranged in the blank areas (see (b) of FIG. 5). Next, the following description discusses, with reference to FIG. 6, an example of a process to be carried out in a case where the number of the blank areas is smaller than that of the files stored in the selected folder. (a) of FIG. 6 illustrates an operation carried out by the user with respect to the display screen, and (b) through (d) of FIG. 6 illustrate display screens after the operation shown in (a) of FIG. 6 has been carried out. Note that the operation illustrated in (a) of FIG. 6 is identical to that illustrated in (a) of FIG. 5. On the display screen illustrated in (a) of FIG. 6, there exist (i) a blank area for one icon on a left side of the “folder 1” icon and (ii) a blank area for one icon on an upper left side of the “folder 1” icon. In a case where the user has carried out a pinch-out operation as shown in (a) of FIG. 6, the smartphone 1 carries out the processes identical to those described with reference to FIG. 5.

Unlike the display screen shown in FIG. 5, the number of blank areas which exist on the display screen illustrated in (a) of FIG. 6 is smaller than that of the files stored in the selected folder. In such a case, the smartphone 1 may (i) move the file(s) stored in the selected folder (“folder 1” folder) by the number of file(s) that can be arranged in the blank area(s) adjacent to the selected folder and (ii) display the moved file(s) on the display screen ((b) of FIG. 6). Alternatively, the smartphone 1 may (i) move the file(s) stored in the selected folder by the number of file(s) that can be arranged in the blank area(s) on the entire display screen and (ii) display the moved files on the display screen ((c) of FIG. 6). Further alternatively, the smartphone 1 may (i) move the file(s) stored in the selected folder by the number of file(s) that can be arranged in the blank area(s) and then (ii) move the rest of the files stored in the selected folder to the display screen such that the rest of the files are arranged near the arrangement position of the selected folder by pushing away objects which have been originally displayed on the display screen ((d) of FIG. 6). Note that, in such a case where not all the files stored in the selected folder are to be moved, the move target file can be selected from all the files stored in the selected folder in any manner. For example, the move target file may be determined in accordance with attributes (e.g., a name, detailed information, and an extension (format)) of each of files stored in the selected folder, a size of an icon, and the like.

By carrying out the above process, the smartphone 1 can allow the user to select a folder and move files stored in the folder to the display screen with a single pinch-out operation so as to arrange the files on the display screen, even in a case where the display list 41 and the arrangement pattern 42 are not used.

### Embodiment 3

In Embodiments 1 and 2, the operation determination section 11 in accordance with the present invention may (i) further determine a direction of the pinch-out operation in accordance with the tracks of touch coordinates received from the input section 20 and (ii) transmit, to the file moving section 13, a piece of information indicative of the direction of the pinch-out operation. In addition, in a case where the operation determination section 11 can determine a direction of a pinch-out operation, the file moving section 13 may determine, in accordance with the direction of the pinch-out operation received from the operation determination section 11, an arrangement position (or a display priority) of an object associated with the move target file, in a case where the display list 41 is updated or in a case where the arrangement position of the move target file on the display screen is determined.

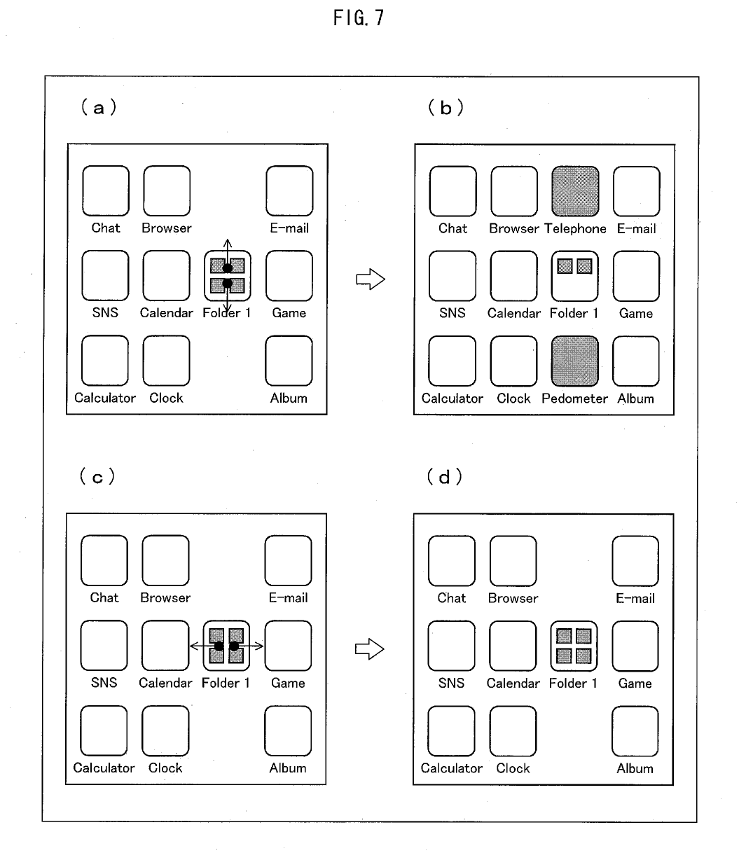

FIG. 7 illustrates an operation and display control to be carried out by the smartphone 1 in response to the user's operation in a case where an arrangement position of an icon indicative of the move target file is to be determined in accordance with the direction of the pinch-out operation. Each of (a) and (c) of FIG. 7 illustrates an operation carried out by the user with respect to the display screen, and (b) and (d) of FIG. 7 respectively illustrate display screens after the operations illustrated in (a) and (c) of FIG. 7 have been carried out. Note that each view of FIG. 7 illustrates an operation carried out in a case where the display list 41 and the arrangement pattern 42 are not used as with Embodiment 2 (i.e., in a case where blank areas exist on the display screen), but the technique according to Embodiment 3 is also applicable to a case where the display list 41 and the arrangement pattern 42 are used as with Embodiment 1. The same applies to the embodiment and the modified example below.

Here, the following description discusses an example case where a pinch-out operation has been carried out with respect to a “folder 1” icon as illustrated in (a) and (c) of FIG. 7. In this case, the operation determination section 11 determines (i) whether or not a pinch-out operation has been carried out and (ii) a direction of the pinch-out operation (in this case, a vertical direction) in accordance with tracks of touch coordinates obtained from the input section 20. The operation determination section 11 then transmits results of the determinations to the file moving section 13. The file moving section 13 determines the number of and an arrangement position of the move target file, in accordance with (i) a piece of information received from the object specifying section 12 and indicative of the selected folder, (ii) a piece of information received from the operation determination section 11 and indicative of the direction of the pinch-out operation, and (iii) arrangement positions which are of objects being displayed on the display screen and have been read out from the storage section 40.

By carrying out the above process, it is possible to determine the number of and the arrangement position of the move target file in accordance with the direction of the pinch-out operation in the following manners. That is, for example, in a case where a pinch-out operation is carried out in a vertical direction on the display screen as illustrated in (a) of FIG. 7, objects which are associated with files are arranged in blank areas on respective upper and lower sides (in a vertical direction) of the selected folder ((b) of FIG. 7). Alternatively, in a case where a pinch-out operation is carried out in a horizontal direction on the display screen as illustrated in (c) of FIG. 7, the objects which are associated with the files are not arranged on the display screen (i.e., the files are not moved) because there exists no blank area on both right and left sides (in a horizontal direction) of the selected folder ((d) of FIG. 7). The smartphone 1 therefore can, in response to the user's intuitive operation, (i) move a file stored in a user's intended folder to the display screen and (ii) arrange the file at a user's intended position.

### Embodiment 4

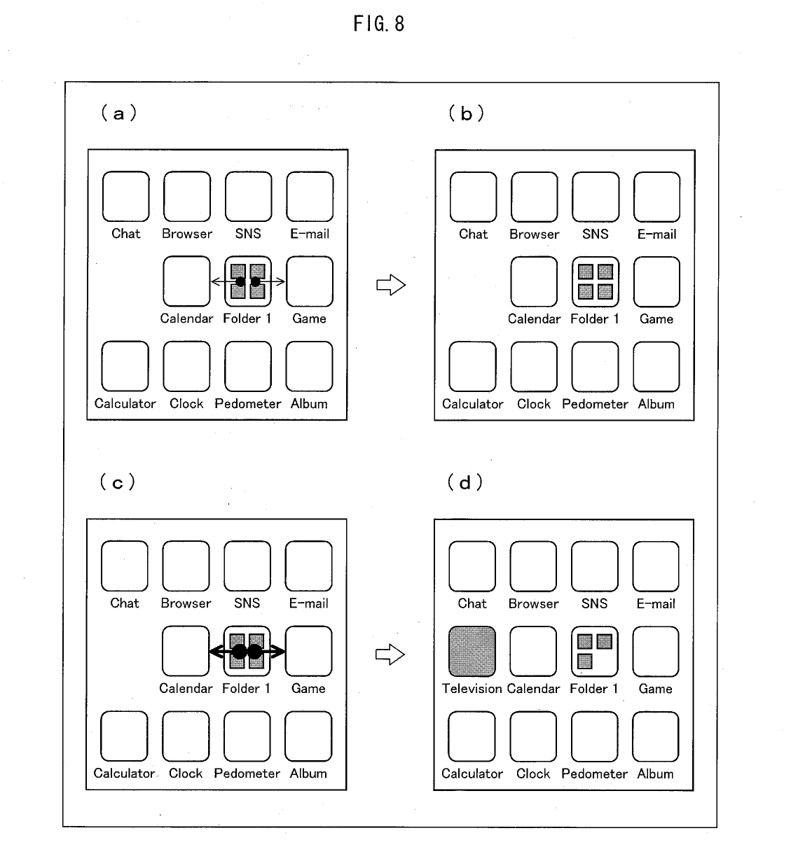

In Embodiments 1 through 3, the smartphone 1 in accordance with the present invention may determine, in accordance with strength of or a speed of a pinch-out operation, the number of and an arrangement position of a folder to be moved from the selected folder to the display screen. FIG. 8 shows an operation and display control to be carried out by the smartphone 1 in response to the user's operation in a case where an arrangement position of an icon indicative of the move target file is to be determined in accordance with strength (or a speed) of the pinch-out operation. Note that a difference in line thickness of arrows between (a) and (c) of FIG. 8 indicates a difference in strength (or a speed) of the pinch-out operation. (c) of FIG. 8 illustrates that the user has carried out an operation stronger (faster) than that illustrated in (a) of FIG. 8. Upon receipt of a pinch-out operation by the user ((a) and (c) of FIG. 8), the input section 20 first detects strength (pressure) of or a speed of the touch input carried out by the user, and transmits a result of the detection to the operation determination section 11. Subsequently, the operation determination section 11 determines (i) whether or not the touch operation is a pinch-out operation and, (ii) in accordance with strength (or a speed) of the received input operation, a degree of strength (or a speed) of the pinch-out operation. The operation determination section 11 then transmits results of the determinations to the file moving section 13. In accordance with the degree of strength (or the speed) of the pinch-out operation which degree has been received from the operation determination section 11, the file moving section 13 determines the number of and an arrangement position of an object associated with the move target file, and stores these pieces of information in a case where the display list 41 is updated or in a case where the arrangement position of the move target file on the display screen is determined.

By carrying out the above process, it is possible to determine the number of and a destination of the move target file in accordance with strength (or a speed) of a pinch-out operation in the following manner. That is, in a case where a weak (or slow) pinch-out operation has been carried out on the display screen as illustrated in (a) of FIG. 8, objects which are associated with files are not arranged in blank areas that are apart from the selected folder (i.e., blank areas that are not adjacent to the selected folder) ((b) of FIG. 8). Alternatively, in a case where a strong (or fast) pinch-out operation has been carried out on the display screen as illustrated in (c) of FIG. 8, the objects which are associated with the files are arranged also in the blank areas that are apart from the selected folder ((d) of FIG. 8). The smartphone 1 therefore can determine, in response to a single predetermined operation, the number of and the arrangement position of the move target file.

### Modified Example

In Embodiments 1 through 4, the file moving section 13 may determine the arrangement position of the move target file on the display screen in accordance with attributes (e.g., a name, detailed information, and an extension (format)) of the move target file and attributes of objects which are displayed on the display screen. More specifically, the file moving section 13 first specifies the move target file in a manner similar to Embodiments 1 through 4. The file moving section 13 then refers to the storage section 40 and reads out the attributes of the move target file and the attributes of the objects which are being displayed on the display screen. Subsequently, the file moving section 13 determines the arrangement position of the move target file so that the move target file is to be arranged near an object having an attribute identical (e.g., in extension (format), in category of a predetermined file name, or the like) to that of the move target file.

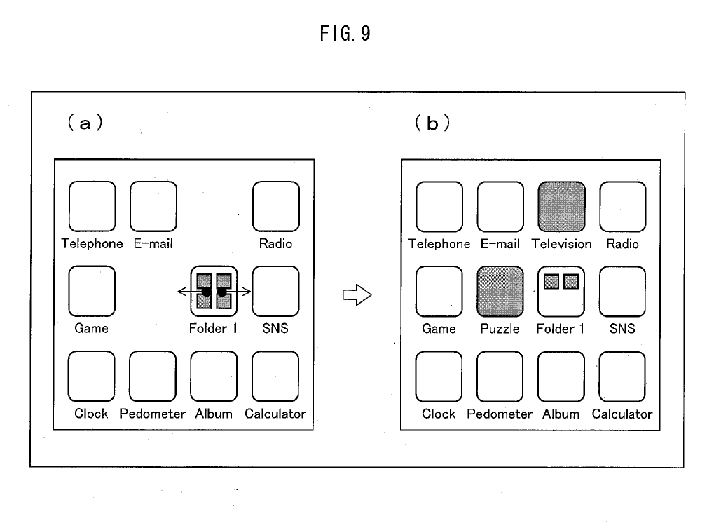

The following description specifically discusses the above process with reference to FIG. 9. FIG. 9 shows examples of (i) an operation to be carried out by a user with respect to the smartphone and (ii) a display screen. Note that, though not illustrated in FIG. 9, a folder indicated by a “folder 1” icon in (a) of FIG. 9 stores shortcut files “television” and “puzzle”. The following description discusses a case where a pinch-out operation has been carried out on the display screen as illustrated in (a) of FIG. 9. In a case where, for example, the “television” and “puzzle” shortcut files each of which is the move target file are respectively identical in category of the predetermined file name (attribute) with “radio” and “game” shortcut icons, the file moving section 13 determines arrangement positions so that the “television” icon is close to the “radio” icon and the “puzzle” icon is close to the “game” icon, as illustrated in (b) of FIG. 9.

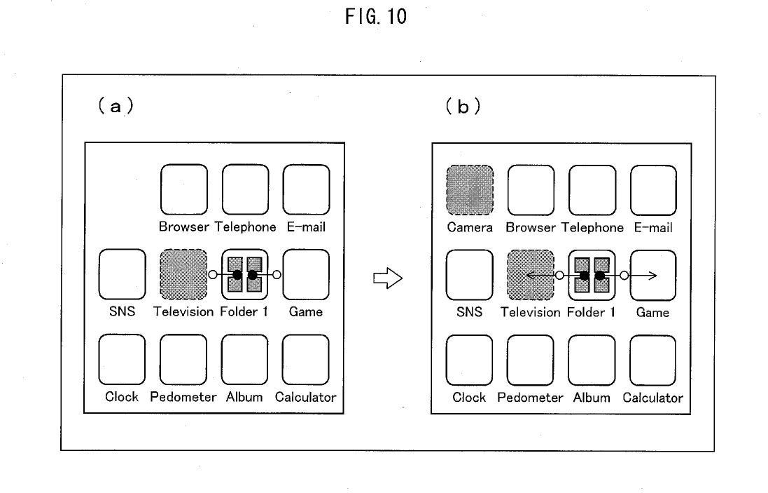

Note that in Embodiments 1 through 4, the smartphone 1 may indicate the move target file and the arrangement position of the move target file on the display screen before the pinch-out operation carried out by the user is ended (i.e., before the user brings his/her fingers off from the display screen). The following description specifically discusses the above process with reference to FIG. 10. FIG. 10 shows examples of (i) an operation to be carried out by a user with respect to the smartphone and (ii) a display screen. Note that white dots illustrated in (a) and (b) of FIG. 10 each indicate a point at which a finger of the user is kept in contact with the display screen. The following description discusses a case where a predetermined time period has elapsed while a pinch-out operation with respect to the icon “folder 1” is kept (i.e., while fingers are being spread and in contact with the display screen) on the smartphone 1 as illustrated in (a) of FIG. 10. In such a case, the input section 20 transmits, to the operation determination section 11, tracks of the touch operation which has been carried out until when the predetermined time period has elapsed. The operation determination section 11 then determines whether or not a pinch-out operation is being carried out, in a manner similar to those in Embodiments 1 through 4. Processes which follow the determination are also to be carried out in a manner similar to those in Embodiments 1 through 4. Lastly, at a timing of updating the display list 41 or at a timing of determining the arrangement position of the move target file, the file moving section 13 only needs to “temporarily determine” the display list 41 or the arrangement position of the move target file in a manner similar to those in Embodiments 1 through 4, instead of completely updating the display list 41 or determining the arrangement position as early described. As illustrated in (b) of FIG. 10, the display update section 14 and the display section 30 can notify the user of the “temporarily determined” position of the move target file by displaying the temporarily determined position in a manner different from a manner in which other objects (whose positions have been completely determined) are displayed, e.g., with a dotted line or a shadow of an icon.

As such, it is possible to notify, in advance, the user of what file is to be moved and where the file is to be arranged when a pinch-out operation is ended. This makes it possible to move a user's intended file and arrange the user's intended file at a user's intended position.

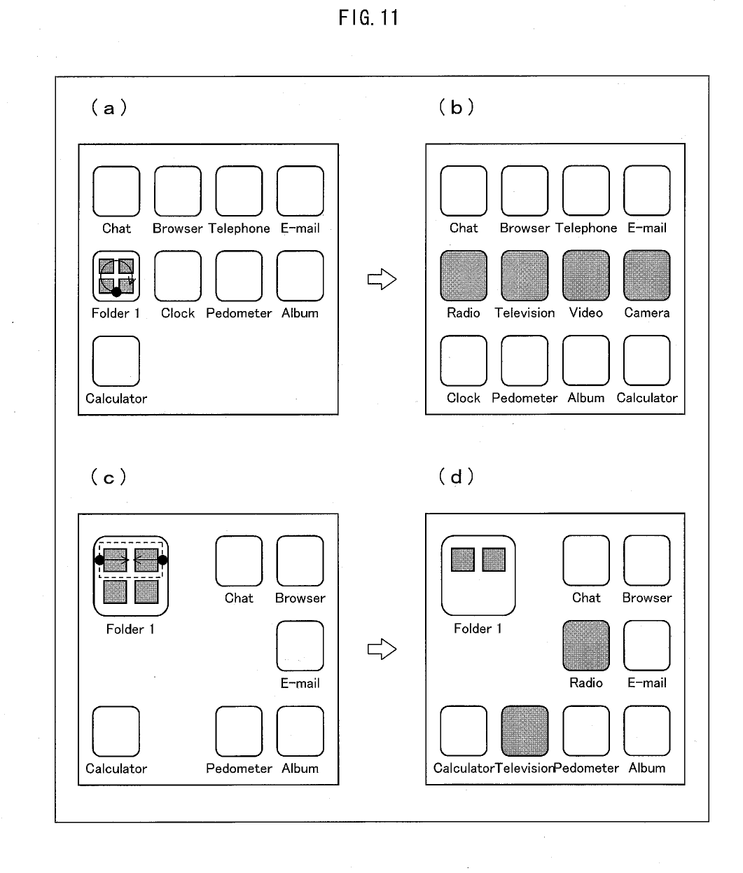

Note that a type of operation to be determined by the operation determination section 11 is not limited to the pinch-in operation as described in Embodiments 1 through 3. For example, the operation determination section 11 may detect, as the predetermined operation, an operation in which the user touches the input surface (display screen) with a single finger (indicator) and moves the finger so as to draw a circular shape (i.e., so that a track of touch coordinates makes a circle) ((a) of FIG. 11). In such a case, the operation determination section 11 transmits, instead of starting points of a pinch-out operation, coordinates representing a center of gravity of the track of the operation (i.e., coordinates representing a center of gravity of the circle) to the object specifying section 12. The object specifying section 12 then specifies a selected object based on the coordinates representing the center of gravity. By carrying out these processes, it is possible to move and arrange files stored in the selected folder in a manner similar to those in Embodiments 1 through 4 ((b) of FIG. 11). Note that, in a case where the selected folder is specified based on one touch (single touch) and a track thereof, the input section 20 does not necessarily need to be capable of detecting multiple touches. In a case where an icon of a file that is stored in a folder is displayed within an icon which indicates the folder, it is possible to employ a configuration in which a predetermined operation (e.g., a pinch-in operation illustrated in (c) of FIG. 11) carried out on the icon of the file that is stored in the folder is detected and then the file, on which the operation has been carried out, is moved to and arranged on the display screen.

### Software Implementation Example

Control blocks of the smartphone 1 (particularly, the object specifying section 12 and the file moving section 13) can be realized by a logic circuit (hardware) provided in an integrated circuit (IC chip) or the like or can be alternatively realized by software as executed by a CPU (Central Processing Unit).

In the latter case, the smartphone 1 includes a CPU that executes instructions of a program that is software realizing the foregoing functions; ROM (Read Only Memory) or a storage device (each referred to as “storage medium”) in which the program and various kinds of data are stored so as to be readable by a computer (or a CPU); and RAM (Random Access Memory) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Main Points]

An information processing apparatus (smartphone 1) in accordance with Aspect 1 of the present invention includes: a display section (display section 30) for displaying an object on a display screen; an input section (input section 20) for detecting a contact position of an indicator on the display screen; an object specifying unit (object specifying section 12) for specifying, based on the contact position detected by the input section, at least one object from objects which are displayed on the display screen; and a file moving unit (file moving section 13) for, in a case where the at least one object (selected object) is associated with a folder, moving a file stored in the folder (selected folder) to an outside of the folder.

According to the above arrangement, the file moving unit moves, in accordance with the contact position detected by the input section, a file which is stored in a folder (selected folder), associated with the specified object, to the outside of the folder. Thus, by merely detecting a touch operation carried out by the user, the information processing apparatus can move a file stored in a folder, which corresponds to an object (folder icon) displayed on the display screen, to the outside of the folder (i.e., to the display screen). It is therefore possible to provide the information processing apparatus that makes it possible to more efficiently carry out an operation to move a file stored in a folder to the outside of the folder.

Further, the file moving unit can (i) specify any number of files regardless of the number of and types of the files, provided that the files are stored in the selected folder, and (ii) collectively move the files in response to a single operation. It is therefore possible to provide the information processing apparatus that allows the user to efficiently carry out an operation to move a file stored in a folder to the outside of the folder, regardless of the number of files that are stored in the folder.

In Aspect 2 of the present invention, the information processing apparatus further includes, in Aspect 1 of the present invention, an operation determination unit (operation determination section 11) for determining, in accordance with the contact position detected by the input section, whether or not a predetermined operation has been carried out, in a case where the operation determination unit has determined that the predetermined operation had been carried out, the object specifying unit specifying, based on the contact position detected by the input section, at least one object from objects which are displayed on the display screen.

According to the above arrangement, in a case where the operation determination unit has determined that the predetermined operation had been carried out, the object specifying unit specifies, based on the contact position detected by the input section, at least one object from objects displayed on the display screen. From this, in a case where the indicator has made contact with the display screen and the predetermined operation has been carried out by the indicator, i.e., in a case where a single predetermined operation has been carried out by the user, the object specifying unit specifies an object which has been selected by the single predetermined operation. The file moving unit then moves a file stored in the folder which is associated with the specified object. This allows the user to efficiently carry out an operation to move a file stored in an intended folder to the outside of the intended folder.

In Aspect 3 of the present invention, the information processing apparatus is arranged such that, in Aspect 2 of the present invention, the predetermined operation to be determined by the operation determination unit is a pinch-out operation.

According to the above arrangement, the user can specify the selected folder and move a file stored in the selected folder by carrying out a pinch-out operation which makes the user intuitively think of an action of “spreading” something. This allows the user to move a file stored in an intended folder to the outside of the intended folder with an intuitive operation.

In Aspect 4 of the present invention, the information processing apparatus further includes, in any one of Aspects 1 through 3 of the present invention, a position specifying unit (file moving section 13) for, in a case where the at least one object is associated with a folder, specifying a first arrangement position (a display priority or an arrangement position stored in the storage section 40) of the at least one object on the display screen; and a file arrangement determination unit (file moving section 13) for determining, in accordance with the first arrangement position, a second arrangement position of an object on the display screen, the object being associated with the file which has been moved by the file moving unit.

According to the above arrangement, the file arrangement determination unit determines, in accordance with information indicative of the arrangement position of the selected object on the display screen, which position has been specified by the position specifying unit, an arrangement position of a file to be moved from the selected folder. This makes it possible to display a file which has been moved from the folder (i.e., a file whose storage location has been changed) at a position associated with a position at which the selected folder was originally arranged. This therefore allows the user to intuitively recognize a destination (arrangement position) to which the file has been moved.

In Aspect 5 of the present invention, the information processing apparatus further includes, in Aspect 2 or 3, a position specifying unit (file moving section 13) for, in a case where the at least one object is associated with a folder, specifying a first arrangement position (a display priority or an arrangement position stored in the storage section 40) of the at least one object on the display screen; and a file arrangement determination unit (file moving section 13) for determining a second arrangement position of an object on the display screen, the object being associated with the file (move target file) which has been moved by the file moving unit, the file arrangement determination unit determining the second arrangement position in accordance with (i) the first arrangement position and (ii) a direction of the predetermined operation, the direction of the predetermined operation being detected by the operation determination unit.

According to the above arrangement, the file arrangement determination unit determines, in accordance with the direction of the predetermined operation detected by the operation determination unit, the arrangement position of the object which is associated with the file. According to the configuration, the information processing apparatus can arrange an object associated with a file in a direction in which the user has carried out an operation on the display screen. Therefore, the information processing apparatus can move and arrange a file stored in a user's intended folder with an intuitive operation carried out by the user.

A control method in accordance with Aspect 6 of the present invention is a method for controlling an information processing apparatus including (i) a display section for displaying an object on a display screen and (ii) an input section for detecting a contact position of an indicator on the display screen, the control method including the steps of: (a) specifying, based on the contact position detected by the input section, at least one object from objects which are displayed on the display screen (S16); and (b) moving, in a case where the at least one object specified in the step (a) is associated with a folder, a file stored in the folder to an outside of the folder (S22).

The information processing apparatus according to each embodiment of the present invention can be realized by a computer. In this case, the present invention also encompasses (i) a control program for causing a computer to operate as each of the units included in the information processing apparatus so as to realize the information processing apparatus by the computer and (ii) a computer-readable storage medium in which the control program is stored.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to an electronic device including a touch panel. Specifically, the present invention is suitably applicable to a smartphone and a tablet information terminal, and the like.

### REFERENCE SIGNS LIST

1 Smartphone (information processing apparatus)
11 Operation determination section (operation determination unit)
12 Object specifying section (object specifying unit)
13 File moving section (file moving unit, file arrangement determination unit, position specifying unit)
20 Input section
30 Display section

1. An information processing apparatus comprising:
a display section for displaying an object on a display screen;
an input section for detecting a contact position of an indicator on the display screen;
an object specifying unit for specifying, based on the contact position detected by the input section, at least one object from objects which are displayed on the display screen; and
a file moving unit for, in a case where the at least one object is associated with a folder, moving a file stored in the folder to an outside of the folder.

2. The information processing apparatus as set forth in claim 1, further comprising:
an operation determination unit for determining, in accordance with the contact position detected by the input section, whether or not a predetermined operation has been carried out,
in a case where the operation determination unit has determined that the predetermined operation had been carried out, the object specifying unit specifying, based on the contact position detected by the input section, at least one object from objects which are displayed on the display screen.

3. The information processing apparatus as set forth in claim 2, wherein:
the predetermined operation to be determined by the operation determination unit is a pinch-out operation.

4. The information processing apparatus as set forth in claim 1, further comprising:
a position specifying unit for, in a case where the at least one object is associated with a folder, specifying a first arrangement position of the at least one object on the display screen; and
a file arrangement determination unit for determining, in accordance with the first arrangement position, a second arrangement position of an object on the display screen, the object being associated with the file which has been moved by the file moving unit.

5. The information processing apparatus as set forth in claim 2, further comprising:
a position specifying unit for, in a case where the at least one object is associated with a folder, specifying a first arrangement position of the at least one object on the display screen; and
a file arrangement determination unit for determining a second arrangement position of an object on the display screen, the object being associated with the file which has been moved by the file moving unit,
the file arrangement determination unit determining the second arrangement position in accordance with (i) the first arrangement position and (ii) a direction of the predetermined operation,
the direction of the predetermined operation being detected by the operation determination unit.

6. A method for controlling an information processing apparatus including (i) a display section for displaying an object on a display screen and (ii) an input section for detecting a contact position of an indicator on the display screen,
said method comprising the steps of:
(a) specifying, based on the contact position detected by the input section, at least one object from objects which are displayed on the display screen; and
(b) moving, in a case where the at least one object specified in the step (a) is associated with a folder, a file stored in the folder to an outside of the folder.
